(19) United States
(12) Patent Application Publication
(10) Pub. No.: US 2014/0168059 A1
(43) Pub. Date: Jun. 19, 2014

(54) METHOD AND SYSTEM FOR RECOGNIZING GESTURE

(71) Applicant: HYUNDAI MOTOR COMPANY, Seoul (KR)

(72) Inventor: Sung Un Kim, Yongin (KR)

(21) Appl. No.: 13/941,779

(22) Filed: Jul. 15, 2013

(30) Foreign Application Priority Data
Dec. 18, 2012 (KR) 10-2012-0148598

(51) Int. Cl. G06F 3/01

(52) U.S. Cl. CPC G06F 3/017
USPC 345/156

(57) ABSTRACT

A method and system that recognize include capturing a hand image using an imaging device. In addition, a controller is configured to produce a template image which is symmetric with a primary captured hand image and match and compare each frame of the captured hand image to the template image in the shooting a hand image. Using the matching information, the controller is further configured to recognize a motion of the hand gesture.

### CROSS-REFERENCE TO RELATED APPLICATION

This application claims priority to and the benefit of Korean Patent Application No. 10-2012-0148598 filed in the Korean Intellectual Property Office on Dec. 18, 2012, the entire contents of which are incorporated herein by reference.

### BACKGROUND

(a) Field of the Invention

The present invention relates to a method and a system that recognizes a gesture. More particularly, the present invention relates to a method and a system that recognizes a gesture from a hand movement.

(b) Description of the Related Art

Generally, gesture recognition based on an image requires pretreatment to obtain the image from an imaging device and remove background images and noise. The gesture recognition is a process that obtains information about an object by detecting an object to be recognized, extracting features of the object, and comparing the features of the object with a learned algorithm or a pattern. In particular, treatment of an image for treating pixel data of an imaging device requires the ability to treat a substantial amount of information. In the treatment of information, a high cost of a system, a complex system, and a long duration for treating information may be required.

Meanwhile, recognition performance may be deteriorated by deviation of a body and a gesture in ordinary gesture recognition. Further, ordinary gesture recognition may require a database that stores a significant amount of information relating to images and gestures, and may require processing power for matching the pattern.

The above information disclosed in this section is only for enhancement of understanding of the background of the invention and therefore it may contain information that does not form the prior art that is already known in this country to a person of ordinary skill in the art.

### SUMMARY

The present invention provides a method and a system that recognizes a gesture having advantages of recognizing a gesture by comparing a current hand image to a template image.

In the method for recognizing a gesture according to an exemplary embodiment of the present invention through recognizing a hand gesture of a user via a system for recognizing a gesture, the method may include: capturing a hand image of user; producing a template image which is symmetric with a primary hand image of the captured hand image; matching and comparing the captured hand image of each frame to the template image in the capturing a hand image; and recognizing a motion of the hand gesture using the matching information.

The recognition of the motion may include recognizing a leftward gesture or a rightward gesture. In addition, the recognition of the motion may include recognizing a downward gesture or an upward gesture. The matching the hand image to the template image may including gaining and producing only a region of interest (ROI) using an image difference based on the motion.

The system that recognizes a gesture according to an exemplary embodiment of the present invention may include: a capturing unit configured to capture a plurality of hand images; and a recognition unit configured to recognize a motion of a hand gesture by producing a template image which is symmetric with a primary hand image of the captured hand images, and by matching and comparing the captured hand image of each frame to the template image.

The recognition unit may include: an extracting unit configured to produce the template image which is symmetric with the primary captured hand image; a matching unit configured to match and compare the captured hand image of each frame to the template image; and an inferring unit configured to recognize the motion of the hand gesture.

The inferring unit may be configured to recognize a leftward gesture or a rightward gesture. In addition, the inferring unit may be configured to recognize a downward gesture or an upward gesture. The matching unit may be configured to gain and produce only the region of interest (ROI) using an image difference according to the motion.

### BRIEF DESCRIPTION OF THE DRAWINGS

FIG. 1 is an exemplary diagram of a system that recognizes a gesture according to an exemplary embodiment of the present invention;

FIG. 2 illustrates exemplary hand images for recognizing a leftward/rightward gesture and an upward/downward gesture according to an exemplary embodiment of the present invention;

FIG. 3 illustrates the exemplary recognition of a leftward gesture according to an exemplary embodiment of the present invention;

FIG. 4 illustrates the exemplary recognition of a downward gesture according to an exemplary embodiment of the present invention;

FIG. 5 illustrates an exemplary leftward gesture recognized by a pattern matching of hand images according to an exemplary embodiment of the present invention; and

FIG. 6 is an exemplary flowchart showing a process of a method for recognizing a gesture according to an exemplary embodiment of the present invention.

Description of Symbols

| | |
|---|---|
| 110: capturing unit | 120: recognition unit |
| 122: extracting unit | 124: matching unit |
| 126: inferring unit | |

### DETAILED DESCRIPTION

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the whole specification, unless explicitly described to the contrary, the word “comprise” and variations such as “comprises” or “comprising” will be understood to imply the inclusion of stated elements but not the exclusion of any other elements.

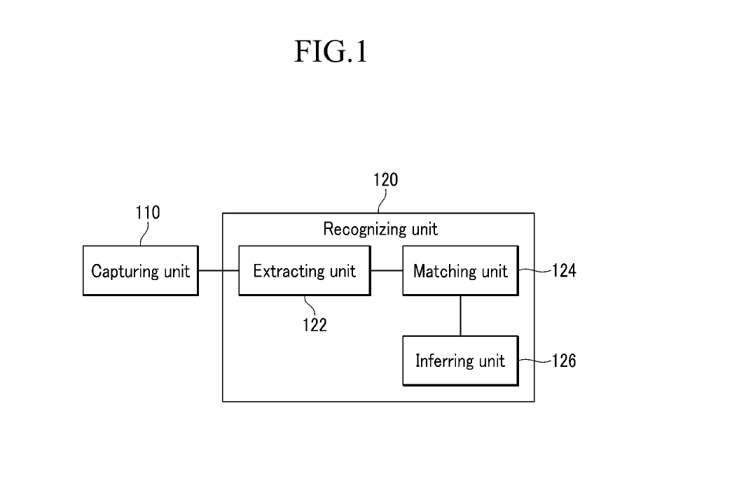

Hereinafter, an exemplary embodiment of the present invention will be described in detail with reference to the accompanying FIG. 1 to FIG. 6.

FIG. 1 is an exemplary diagram of a system that recognizes a gesture according to an exemplary embodiment of the present invention. As shown in FIG. 1, the system that recognizes a gesture may include a plurality of units executed by a controller. The plurality of units may include a capturing unit 110 and a recognition unit 120.

The capturing unit 110 (e.g., an imaging device, camera, video camera, etc.) may be configured to capture a hand image of a user. In addition, the capturing unit 110 may be configured to transmit each frame of the captured hand image to the recognition unit 120. In particular, the hand image captured by the capturing unit 110 may be transmitted to the recognition unit 120 via steps of gaining images, removing background, and pretreatment according to an exemplary embodiment of the present invention, and the elements performing the above mentioned steps are well-known in the art such that a detailed description thereof will be omitted.

The recognition unit 120 may be configured to produce a template image for recognizing a gesture based on the transmitted hand image, and to recognize a hand gesture by comparing the captured image with the template image. In addition, the recognition unit 120 may be configured to compare a current hand image and a primary hand image to be symmetric to each other, and recognize a transition correlation as a gesture motion when the images are symmetric to each other. Furthermore, the recognition unit 120 may include an extracting unit 122, a matching unit 124, and an inferring unit 126.

The extracting unit 122 may be configured to produce the template image using a primary hand image captured by the capturing unit 110. Additionally, the extracting unit 122 may be configured to produce the template image to be symmetric in a leftward and rightward direction (e.g., a horizontal direction) and an upward and downward direction (e.g., a vertical direction) with the primary captured hand image.

The matching unit 124 may be configured to compare and match each frame of the hand image captured by the capturing unit 110 with the template image. In addition, the matching unit 124 may be configured to compare the hand image to vary with the template image of a leftward/rightward gesture or an upward/downward gesture based on whether they are matched.

The inferring unit 126 may be configured to recognize a hand gesture, a command of a user, from the matching result compared in the matching unit 124. The matching unit 124 of the recognition unit 120 may be configured to gain and produce only a region of interest (ROI) using an image difference based on the gesture motion. According to an exemplary embodiment of the present invention, the noise reliability by exterior lighting conditions may have improved results using the recognition unit 120.

Further, according to an exemplary embodiment of the present invention, an additional large capacity memory or database (DB) may be omitted because only the presently captured hand images are used. In addition, there are merits that the position, angle, and image shape of the hand may be anticipated to easily match the template image when the hand gestures are performed to be symmetric with respect to a wrist.

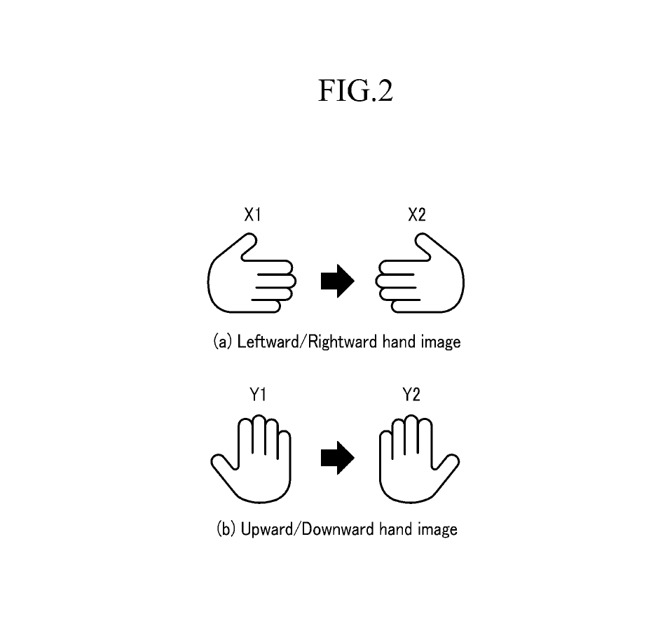

FIG. 2 illustrates exemplary symmetric hand images for recognizing a leftward/rightward gesture and an upward/downward gesture.

Referring to FIG. 2 (a), when a hand image X1 is captured for recognizing a leftward/rightward hand gesture, a hand image X2 which is symmetric to the hand image X1 may be produced as the template image, and when the hand image X2 is captured, the hand image X1 which is symmetric to the hand image X2 may be produced as the template image.

Referring to FIG. 2 (b), when a hand image Y1 is captured for recognizing an upward/downward hand gesture, a hand image Y2 which is symmetric to the hand image Y1 may be produced as the template image, and when the hand image Y2 is captured, the hand image Y1 which is symmetric to the hand image Y2 may be produced as the template image.

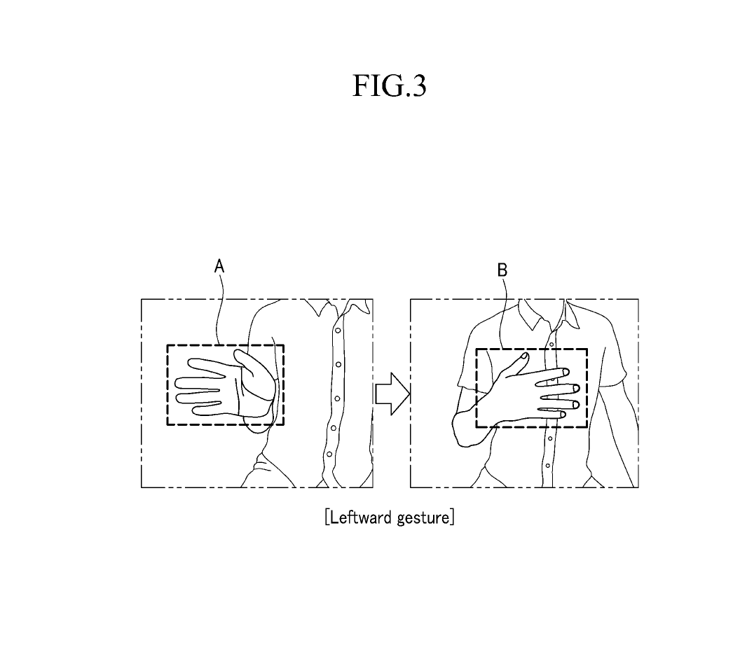

FIG. 3 illustrates the exemplary recognition of a leftward gesture. Referring to FIG. 3, a primary hand image A and a final hand image B of a user are shown when a user performs a leftward gesture. According to an exemplary embodiment of the present invention, the final hand image B which is symmetric to the primary hand image A may be produced as the template image. In addition, the capturing unit 110 may be configured to compare each frame of a presently captured image with the template image to recognize the leftward gesture.

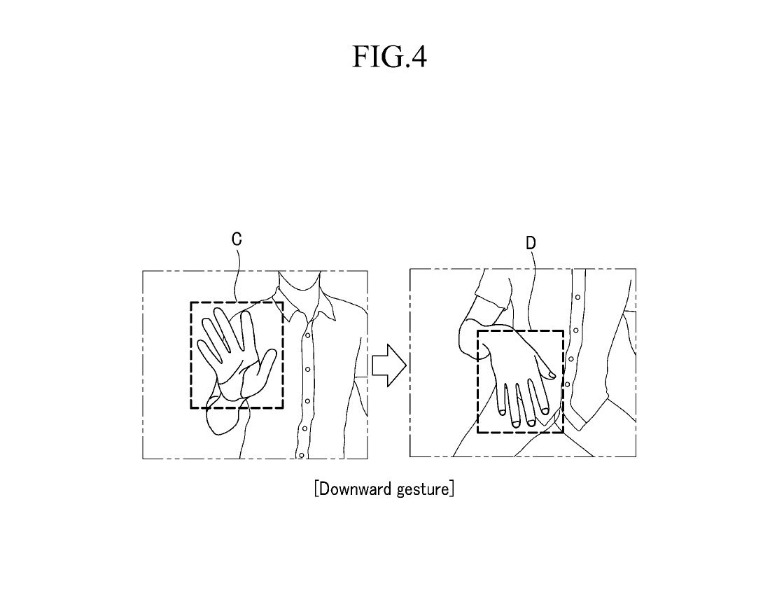

FIG. 4 illustrates the exemplary recognition of a downward gesture. Referring to FIG. 4, a primary hand image C and a final hand image D of a user are shown when a user performs a downward gesture. According to an exemplary embodiment of the present invention, the final hand image D which is symmetric to the primary hand image C may be produced as the template image. In addition, the capturing unit 110 may be configured to compare each frame of a presently captured image with the template image to recognize the downward gesture.

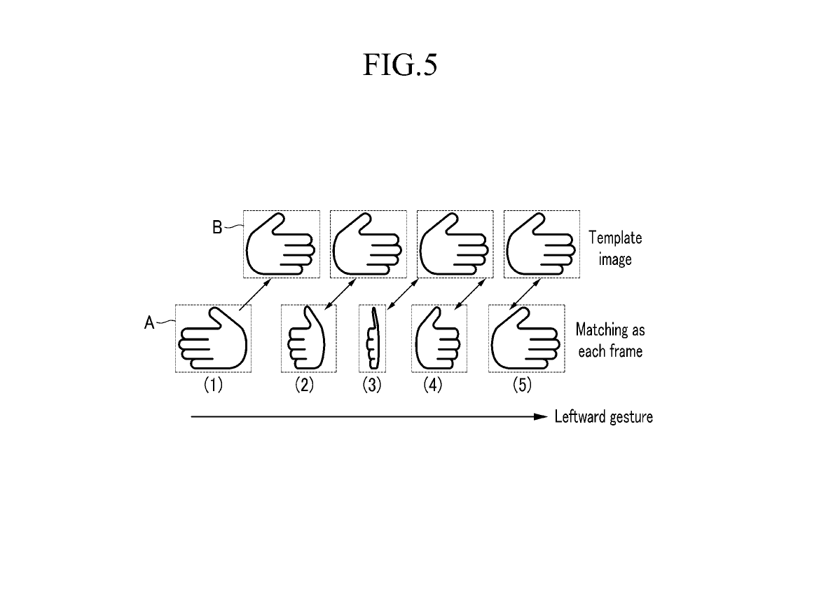

FIG. 5 illustrates an exemplary leftward gesture recognized by a pattern matching of hand images. Referring to FIG. 5, the final hand image B which is symmetric to the primary hand image A may be used with the template image. According to an exemplary embodiment of the present invention, an attempt may be made to respectively match the primary hand image A captured by the capturing unit 110 with the template image B in frames 1 to 5. As shown in FIG. 5, a user may perform the leftward gesture by matching the final hand image of the frame 5 with the template image B.

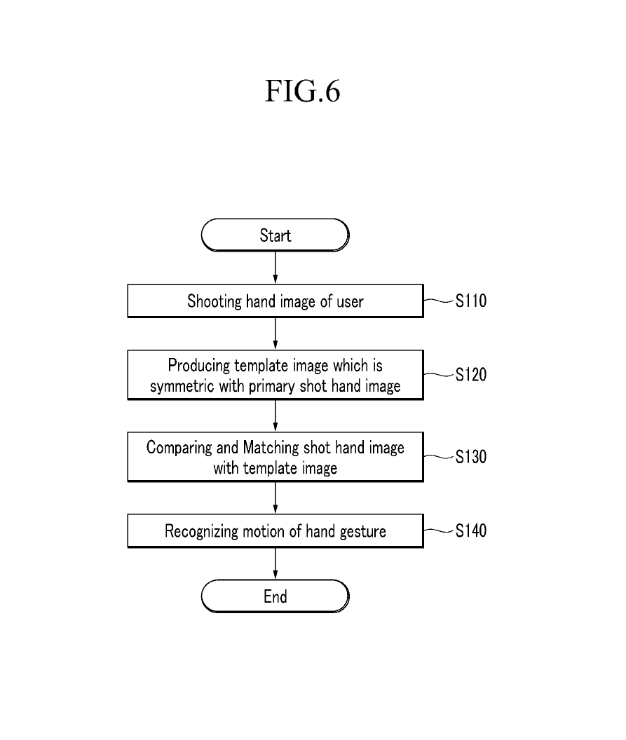

FIG. 6 is an exemplary flowchart showing a process of a method for recognizing a gesture according to an exemplary embodiment of the present invention. Referring to FIG. 6, the method for recognizing a gesture according to an exemplary embodiment of the present invention may include capturing, producing, matching, and recognizing.

The capturing of a hand image of a user may be performed by the capturing unit 110 (e.g., an imaging device, a camera, etc.), executed by a controller, configured to capture each frame of the hand image, and extract the each frame of the captured hand image at step S110. Further, the captured hand image may be transmitted to the recognition unit 120 via steps of gaining images, removing background, and pretreatment, and the elements performing the above mentioned steps are well-known in the art such that a detailed description thereof will be omitted.

The production of a template image may be performed using a primary hand image captured by the capturing unit 110, and the template image which is symmetric to the primary hand image may be produced at step S120. In addition, the template image may be symmetric in a leftward/rightward direction and an upward/downward direction to the primary hand image.

The matching may be performed by comparing and matching each frame of the hand image captured by the capturing unit 110 with the template image at step S130. In the matching process, the varied hand image may be compared with a leftward/rightward gesture or an upward/downward gesture to determine whether they match.

The recognition of a gesture may be performed by recognizing leftward/rightward and upward/downward hand gestures, commands of an user, from the matching result compared in the matching process.

According to an exemplary embodiment of the present invention, an additional large capacity memory or database (DB) may be omitted since a current hand image is compared with a primary hand image to be symmetric to each other using only a presently captured hand image. In addition, there may be merits that the position, angle, and image shape of the hand may be anticipated to easily match the template image based on the hand gestures being performed to be symmetric with respect to a wrist.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. A method for recognizing a hand gesture using a system that recognizes a gesture, the method comprising:
capturing, by an imaging device, a hand image;
producing, by a controller, a template image which is symmetric with a primary captured hand image;
matching and comparing, by the controller, each frame of the captured hand image to the template image; and
recognizing, by the controller, a motion of the hand gesture using the matching information.

2. The method of claim 1, wherein the recognizing the motion includes:
recognizing, by the controller, a leftward gesture or a rightward gesture.

3. The method of claim 1, wherein the recognizing the motion includes:
recognizing, by the controller, a downward gesture or an upward gesture.

4. The method of claim 1, wherein the matching the hand image to the template image includes:
gaining and producing, by the controller, only the region of interest (ROI) using an image difference according to the motion.

5. A system for recognizing a gesture comprising:
an imaging device configured to capture a hand image; and
a controller configured to recognize a motion of a hand gesture by producing a template image which is symmetric with a primary captured hand image and by matching and comparing each frame of the captured hand image to the template image.

6. The system of claim 5, wherein the controller is further configured to:
produce the template image which is symmetric with the primary captured hand image;
match and compare each frame of the captured hand image to the template image; and
recognize the motion of the hand gesture.

7. The system of claim 6, wherein the controller is further configured to recognize a leftward gesture or a rightward gesture.

8. The system of claim 6, wherein the controller is further configured to recognize a downward gesture or an upward gesture.

9. The system of claim 6, wherein the controller is further configured to gain and produce only a region of interest (ROI) using an image difference according to the motion.

10. A non-transitory computer readable medium containing program instructions executed by a processor or controller, the computer readable medium comprising:
program instructions that capture a hand image;
program instructions that produce a template image which is symmetric with a primary captured hand image;
program instructions that match and compare each frame of the captured hand image to the template image; and
program instructions that recognize a motion of the hand gesture using the matching information.

11. The non-transitory computer readable medium of claim 10, further comprising:
program instructions that produce the template image which is symmetric with the primary captured hand image;
program instructions that match and compare each frame of the captured hand image to the template image; and
program instructions that recognize the motion of the hand gesture.

12. The non-transitory computer readable medium of claim 11, further comprising:
program instructions that recognize a leftward gesture or a rightward gesture.

13. The non-transitory computer readable medium of claim 11, further comprising:
program instructions that recognize a downward gesture or an upward gesture.

14. The non-transitory computer readable medium of claim 11, further comprising:
program instructions that gain and produce only a region of interest (ROI) using an image difference according to the motion.
